(19) United States
(12) Patent Application Publication
(10) Pub. No.: US 2015/0135130 A1
(43) Pub. Date: May 14, 2015

(54) CONSOLE WINDOWING SYSTEMS AND METHODS

(71) Applicant: salesforce.com, inc., San Francisco, CA (US)

(72) Inventor: Gautam Vasudev, San Francisco, CA (US)

(21) Appl. No.: 14/542,054

(22) Filed: Nov. 14, 2014

Related U.S. Application Data
(60) Provisional application No. 61/904,337, filed on Nov. 14, 2013.

(51) Int. Cl. G06F 3/0481; G06F 3/0484

(52) U.S. Cl. CPC G06F 3/0481; G06F 3/04842
USPC 715/781

(57) ABSTRACT

A method for accessing a database system includes displaying, on a first display, a main workspace user interface including a plurality of components associated with the database system. A request to create a pop-out representation of a selected component is received via the main workspace user interface. The pop-out representation of the selected component is displayed on at least one of the first display and a second display. The data of the database system is modified in accordance with an operation performed via the main workspace user interface. The pop-out representation of the selected component is managed based on the operation performed via the main workspace user interface.

### CROSS-REFERENCE TO RELATED APPLICATIONS

This application claims priority to U.S. Prov. Pat. App. No. 61/904,337, filed Nov. 14, 2013, the contents of which are hereby incorporated by reference.

### TECHNICAL FIELD

Embodiments of the subject matter described herein relate generally to user interfaces for database systems, and more particularly, to methods and systems for managing windows for consoles used in the context of computer database systems.

### BACKGROUND

Users of database systems often need to display and interact with a wide variety of windows and other components associated with such database systems. For example, contact center agents are typically more productive when they can simultaneously view many windows or components (collectively, a “control panel”) associated with a certain case or task.

User interface components employed in this context might include, for example, chat widgets, calculators, components for managing and receiving calls, components for browsing through database data, and the like. It is common for contact center agents and other users to configure their control panel such that all available monitor “real estate” is used. In some control panel schemes, such as web-based control panels, it is often difficult for the user to visualize information in a way that is tailored to that particular user because all the windows are generally displayed within a single main workspace window (e.g., a web page) that is difficult to distribute across multiple monitors.

Accordingly, methods and systems are desired for improving database system user interfaces.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is conceptual block diagram depicting a database system and computing device in accordance with one embodiment;

FIG. 2 depicts an example prior art user interface implemented within a single main workspace window.

FIG. 3 depicts a user interface in accordance with an example embodiment;

FIG. 4 depicts a user interface in accordance with an alternate embodiment;

FIG. 5 is a flowchart depicting a method in accordance with one embodiment; and

FIG. 6 depicts a multi-tenant system that may be used in connection with various embodiments.

### DETAILED DESCRIPTION

Embodiments of the subject matter described herein generally relate to improved systems and method for managing user interfaces, such as consoles or “control panels” associated with database systems. As described in further detailed below, the systems and methods described herein provide a user interface scheme in which certain components of the main workspace can be “popped-out” in such a way that they may be advantageously arranged by the user over one or more monitors. At the same time, operations performed on the main workspace are reflected in the appropriate pop-up window(s) and/or operations performed within the pop-up window(s) are reflected in the main workspace (and, optionally, other pop-up windows). Stated another way, the main workspace window retains some control of the pop-out windows, such as closing all associated pop-out windows when the main workspace window is itself closed. The configuration of pop-out windows may be saved for the user so that the configuration may be restored at a later time.

In accordance with one embodiment, a method for accessing a database system includes displaying, on a first display, a main workspace user interface including a plurality of components associated with the database system, and receiving, via the main workspace user interface, a request to create a pop-out representation of a selected component. The pop-out representation of the selected component is displayed on at least one of the first display and a second display. The data of the database system is modified in accordance with an operation performed via the main workspace user interface. The pop-out representation of the selected component is managed based on the operation performed via the main workspace user interface.

In accordance with one embodiment, an apparatus includes a database system and a computing device. The computing device is configured to: display, on a first display, a main workspace user interface including a plurality of components associated with the database system; receive, via the main workspace user interface, a request to create a pop-out representation of a selected component; display, on at least one of the first display and a second display, the pop-out representation of the selected component; modify data of the database system in accordance with an operation performed via the main workspace user interface; and manage the pop-out representation of the selected component based on the operation performed via the main workspace user interface.

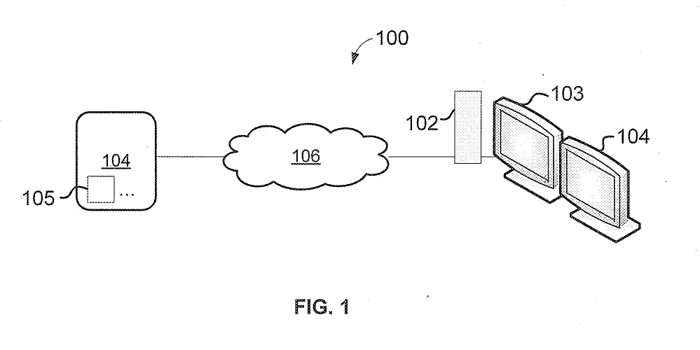

Referring now to the conceptual block diagram depicted in FIG. 1, a system 100 in accordance with one embodiment generally includes a database system 104 (e.g., a database system used in connection with a Contact Center, Service Center, or the like) having one or more database objects 105 stored therein, and a computing device (or simply “device”) 102 communicatively coupled to database system 104 via, for example, a data communication network 106 (such as the Internet). Computing device 102 is coupled to one or more display monitors (or simply “displays”), such as displays 103 and 104. As mentioned above, in the interest of efficiency, it is often desirable for a user to utilize two or more monitors while performing certain tasks, particularly in the context of a Contact Center.

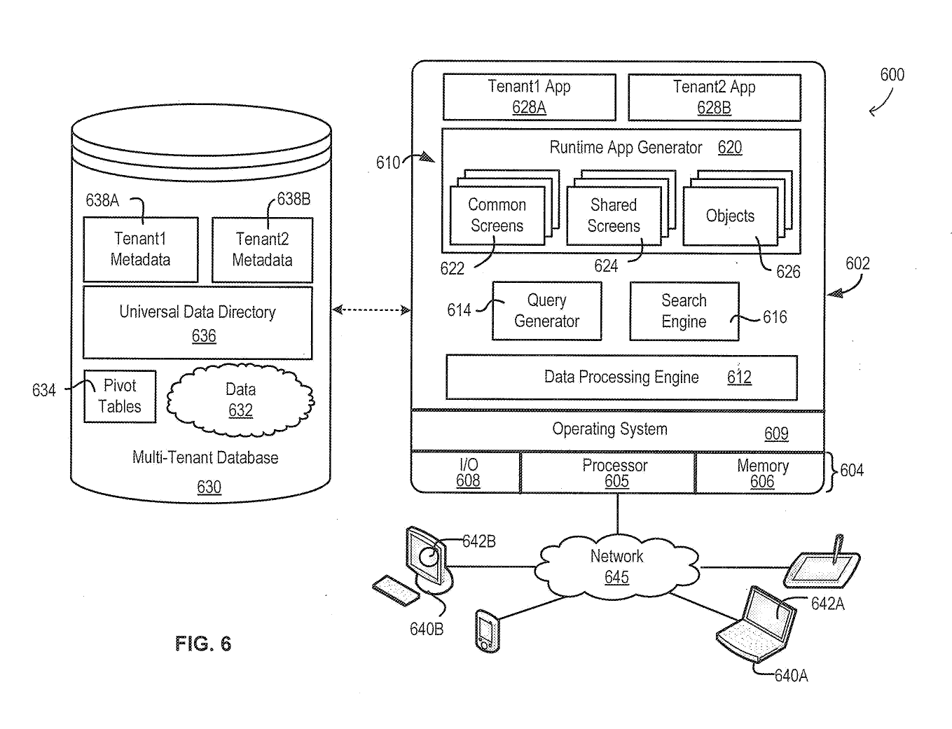

Database system 104 may be implemented using any suitable combination of hardware and software and may correspond to any of a variety of database system types, including, for example, a multi-tenant system as described in further detail below in connection with FIG. 6. Similarly, device 102 may be any combination of hardware and software configured to access database system 104 via network 106 and to provide a user interface (via a suitable display and input/output components) that allow a user to interaction with database system 104 and its objects 105. Device 102 may correspond, for example, to a desktop computer, a laptop computer, a tablet computer, a smart-phone, or the like.

Database object (or simply “object”) 105 may include any combination of tables, schemas, and the like used to store and organize data in database system 104, as is known in the art. The nature of object 105 will typically vary depending on the particular purpose of database system 104. For example, in the context of a customer relationship management (CRM) system, object 105 may correspond to an “account” object, an “opportunity” object, a “contact” object, or the like.

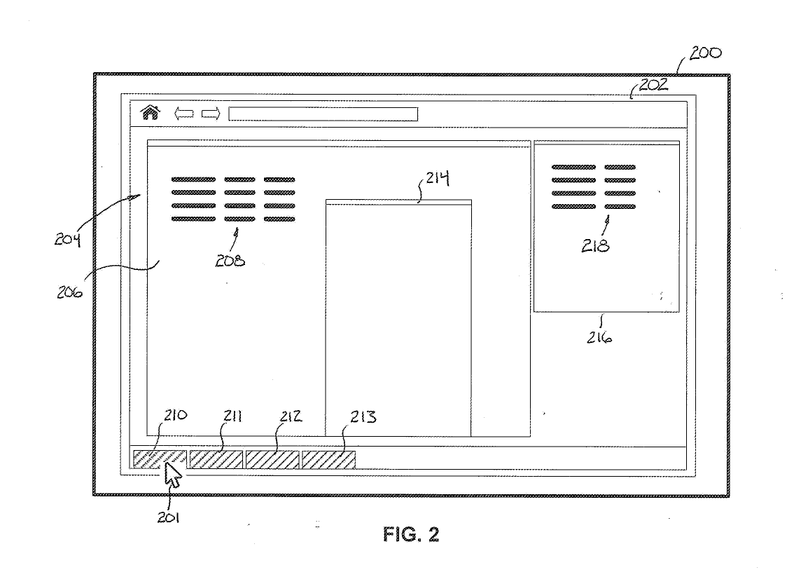

FIG. 2 presents a conventional, single-monitor prior art user interface scheme useful in describing the present invention. As shown, a display 200 is used to view a web browser user interface including a main workspace user interface (or simply “main workspace”) 204 as well as various component user interfaces (or simply “components”) 214 and 216. In general, main workspace 204 includes a window 206 that may be used, for example, to display data 208 (e.g., a list of customer interactions or customer issues for one or more customers), as well as one or more links or buttons 210, 211, 212, 213 that may be actuated (e.g., via a cursor 201) to expand and view various other components, such as components 216 and 214. As shown, component 216 may also be used to display and manipulate data 218. In the illustrated embodiment, links 210-213 are “footer” components in that they are configured adjacent the bottom of window 206 of main workspace 204, but may be consider part of the main workspace 2014 from a functional standpoint. Thus, component 214 is shown expanded from the bottom of window 206 after actuation of a corresponding link (not shown). The term “components” as described herein refers to the various functional capabilities and user interfaces associated with database system 104, other than main workspace 204. That is, while main workspace 204 itself provides various functional capabilities, it exists at a higher level and is distinct from the “components” in that it maintains some control over those components, as described in further detail below. User interface components employed in a Contact Center context might include, for example, chat widgets, calculators, components for managing and receiving calls, components for browsing through database data, and the like. For the purpose of this example and without loss of generality the displayed page may be considered a web page rendered by a web browser running on device 102 using various HTML, CSS, and Javascript files as is known in the art.

It is important to note that, in FIG. 2, the components 216 and 214 are not “pop-out” components; they exist within the main workspace 204 and are restrained by the dimensions of browser 202. Accordingly, use of such a user interface with multiple monitors (e.g., displays 103 and 104 of FIG. 1) would be intractable, due to variations in the resolution and sizes of the displays, as well as the difficulty of horizontally stretching a browser window across multiple monitors.

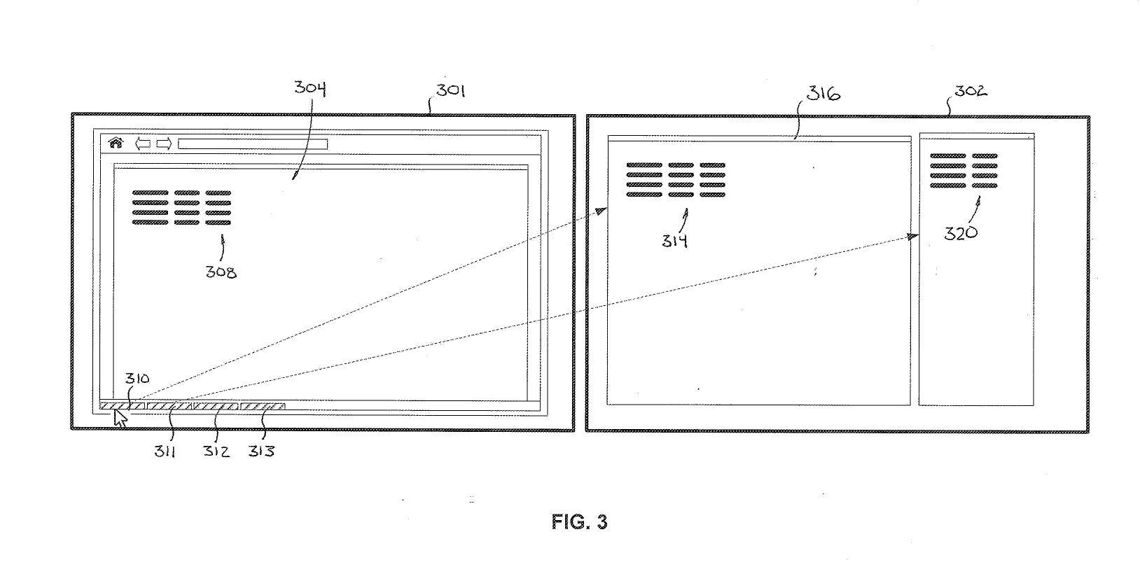

In contrast, FIG. 3 depicts a user interface in accordance with one embodiment of the invention in which two displays (301 and 302) are utilized. More particularly, the system (e.g., of device 102 of FIG. 1) is configured to display, on a first display (e.g., display 301), a main workspace user interface 304 including a plurality of components (represented by links 310-313) associated with the database system (104 of FIG. 1). While FIG. 3 depicts components 310-313 as footer components, the invention is not so limited. Side-bar components and any other form of component may be used in any particular application.

Device 102 is configured to receive, via the main workspace user interface 304, a request to create a pop-out representation (or simply “pop-out”) of a selected component. That is, for example, the user might click on one or more of links 310-313, thereby requesting (via suitable HTML, CSS, and or Javascript code) that a pop-out be displayed. In the illustrated embodiment, it is assumed that the user has clicked on links 310. In response, device 102 is configured to display, on either display 301 or 302 (preferably display 302), the pop-out representations 316 and 318 of the selected components (310, 311). The term “pop-out” as used herein generally refers to an==window (e.g., browser window) that can be manipulated (e.g., moved and scaled) independent of the main workspace 304. Such pop-outs may be implemented in a variety of ways, including HTML, CSS, and or Javascript code, as mentioned above. In accordance with the illustrated embodiment, the search bar, footer, footer components (310, 311), and navigation tab continue to persist within main workspace 304.

As illustrated, pop-outs 316 and 318 may also include respective data, lists, or other content 314 and 320 with which the user may interact. In connection with such interaction, the user might modify data of the database system 104 in accordance with an operation performed via main workspace 304. In response, computing device 102 manages the pop-out representations 316 and 318 of the selected component based on the operation performed via main workspace user interface 304. That is, while components 316 and 318 are “pop-outs”, main workspace 304 maintains some control over their functionality, such that interacting with data 308 may result in a corresponding change in data 314 and/or 320. This management may be implemented via a variety of methods, including standard HTML, CSS, and Javascript code having access to database system 104 and objects 105.

In one embodiment, closing main workspace 304 results in the corresponding components 316 and 318 also being closed. In a further embodiment, the state of the components 316 and 318 (e.g., open/closed, position with respect to displays 301 and 302) is stored such that the user may easily recall that configuration at a later time. In one embodiment, refreshing main workspace 304 causes the system to prompt the user to save any unsaved data.

It will be appreciated that the user interface of FIG. 3 provides a number of advantages. For example, it allows the user to customize his or her workspace across multiple monitors. In addition, the user of pop-out components has a beneficial impact on computing performance, as the Javascript and HTML rendering load is effectively shared among multiple browser windows.

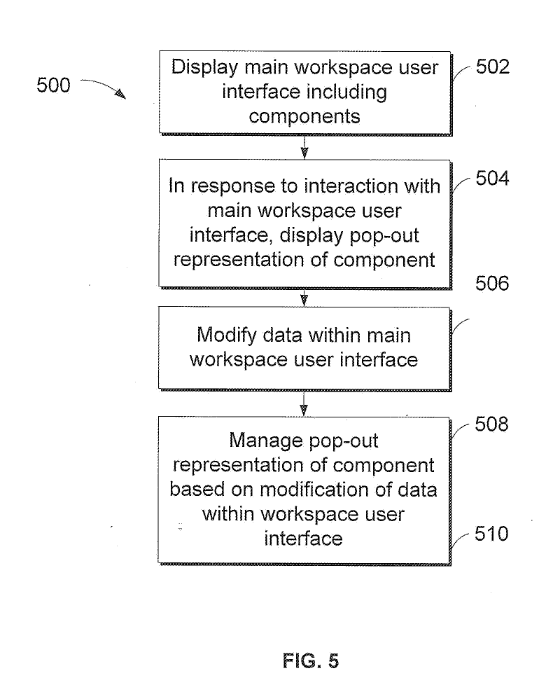

Referring now to the exemplary flowchart 500 of FIG. 5 in conjunction with FIGS. 1 and 3, an exemplary method for console management thus generally includes displaying the main workspace user interface 304 including one or more components (e.g., 310-313) (step 502). In response to interaction with the main workspace user interface 304, the system displays a pop-out representation of the component (e.g., 316 and 318) (step 504). When data within the main workspace user interface 304 is modified (step 506), the system manages pop-outs 316 and 318 based on the modification of data. Likewise, when data within pop-outs 316 or 318 is modified, the system manages main workspace user interface 304 based on the modification of data.

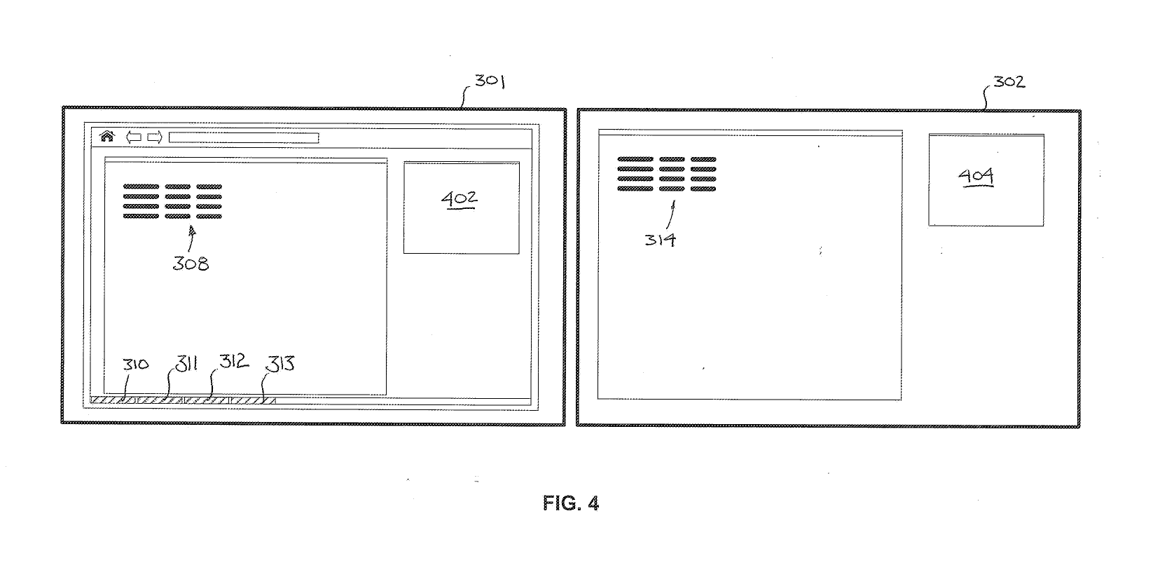

FIG. 4 depicts an alternate embodiment in which main workspace window 304 allows certain components (e.g., 402) to be “anchored” or “pinned” within the main workspace user interface 304, while still implementing those components as “pop-outs” capable of interacting with main workspace 304. Component 404 is shown as being popped out to display 302.

FIG. 6 depicts an exemplary multi-tenant system suitable for implementation of the systems and methods described herein. That is, the various devices 604 may correspond to device 102 of FIG. 1, while the particular database objects 105 may be stored within multi-tenant database 630.

The multi-tenant system 600 of FIG. 6 includes a server 602 that dynamically creates and supports virtual applications 628 based upon data 632 from a common database 630 that is shared between multiple tenants, alternatively referred to herein as a multi-tenant database. Data and services generated by the virtual applications 628 are provided via a network 645 to any number of client devices 640, as desired. Each virtual application 628 is suitably generated at run-time (or on-demand) using a common application platform 610 that securely provides access to the data 632 in the database 630 for each of the various tenants subscribing to the multi-tenant system 600. In accordance with one non-limiting example, the multi-tenant system 600 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 630. In this regard, each tenant includes one or more users associated with, assigned to, or otherwise belonging to that respective tenant. To put it another way, each respective user within the multi-tenant system 600 is associated with, assigned to, or otherwise belongs to a particular tenant of the plurality of tenants supported by the multi-tenant system 600. Tenants may represent customers, customer departments, business or legal organizations, and/or any other entities that maintain data for particular sets of users within the multi-tenant system 600 (i.e., in the multi-tenant database 630). For example, the application server 602 may be associated with one or more tenants supported by the multi-tenant system 600. Although multiple tenants may share access to the server 602 and the database 630, the particular data and services provided from the server 602 to each tenant can be securely isolated from those provided to other tenants (e.g., by restricting other tenants from accessing a particular tenant's data using that tenant's unique organization identifier as a filtering criterion). The multi-tenant architecture therefore allows different sets of users to share functionality and hardware resources without necessarily sharing any of the data 632 belonging to or otherwise associated with other tenants.

The multi-tenant database 630 is any sort of repository or other data storage system capable of storing and managing the data 632 associated with any number of tenants. The database 630 may be implemented using any type of conventional database server hardware. In various embodiments, the database 630 shares processing hardware 604 with the server 602. In other embodiments, the database 630 is implemented using separate physical and/or virtual database server hardware that communicates with the server 602 to perform the various functions described herein. In an exemplary embodiment, the database 630 includes a database management system or other equivalent software capable of determining an optimal query plan for retrieving and providing a particular subset of the data 632 to an instance of virtual application 628 in response to a query initiated or otherwise provided by a virtual application 628. The multi-tenant database 630 may alternatively be referred to herein as an on-demand database, in that the multi-tenant database 630 provides (or is available to provide) data at run-time to on-demand virtual applications 628 generated by the application platform 610.

In practice, the data 632 may be organized and formatted in any manner to support the application platform 610. In various embodiments, the data 632 is suitably organized into a relatively small number of large data tables to maintain a semi-amorphous “heap”-type format. The data 632 can then be organized as needed for a particular virtual application 628. In various embodiments, conventional data relationships are established using any number of pivot tables 634 that establish indexing, uniqueness, relationships between entities, and/or other aspects of conventional database organization as desired. Further data manipulation and report formatting is generally performed at run-time using a variety of metadata constructs. Metadata within a universal data directory (UDD) 636, for example, can be used to describe any number of forms, reports, workflows, user access privileges, business logic and other constructs that are common to multiple tenants. Tenant-specific formatting, functions and other constructs may be maintained as tenant-specific metadata 638 for each tenant, as desired. Rather than forcing the data 632 into an inflexible global structure that is common to all tenants and applications, the database 630 is organized to be relatively amorphous, with the pivot tables 634 and the metadata 638 providing additional structure on an as-needed basis. To that end, the application platform 610 suitably uses the pivot tables 634 and/or the metadata 638 to generate “virtual” components of the virtual applications 628 to logically obtain, process, and present the relatively amorphous data 632 from the database 630.

The server 602 is implemented using one or more actual and/or virtual computing systems that collectively provide the dynamic application platform 610 for generating the virtual applications 628. For example, the server 602 may be implemented using a cluster of actual and/or virtual servers operating in conjunction with each other, typically in association with conventional network communications, cluster management, load balancing and other features as appropriate. The server 602 operates with any sort of conventional processing hardware 604, such as a processor 605, memory 606, input/output features 608 and the like. The input/output features 608 generally represent the interface(s) to networks (e.g., to the network 645, or any other local area, wide area or other network), mass storage, display devices, data entry devices and/or the like. The processor 605 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 606 represents any non-transitory short or long term storage or other computer-readable media capable of storing programming instructions for execution on the processor 605, including any sort of random access memory (RAM), read only memory (ROM), flash memory, magnetic or optical mass storage, and/or the like. The computer-executable programming instructions, when read and executed by the server 602 and/or processor 605, cause the server 602 and/or processor 605 to create, generate, or otherwise facilitate the application platform 610 and/or virtual applications 628 and perform one or more additional tasks, operations, functions, and/or processes described herein. It should be noted that the memory 606 represents one suitable implementation of such computer-readable media, and alternatively or additionally, the server 602 could receive and cooperate with external computer-readable media that is realized as a portable or mobile component or application platform, e.g., a portable hard drive, a USB flash drive, an optical disc, or the like.

The application platform 610 is any sort of software application or other data processing engine that generates the virtual applications 628 that provide data and/or services to the client devices 640. In a typical embodiment, the application platform 610 gains access to processing resources, communications interfaces and other features of the processing hardware 604 using any sort of conventional or proprietary operating system 609. The virtual applications 628 are typically generated at run-time in response to input received from the client devices 640. For the illustrated embodiment, the application platform 610 includes a bulk data processing engine 612, a query generator 614, a search engine 616 that provides text indexing and other search functionality, and a runtime application generator 620. Each of these features may be implemented as a separate process or other module, and many equivalent embodiments could include different and/or additional features, components or other modules as desired.

The runtime application generator 620 dynamically builds and executes the virtual applications 628 in response to specific requests received from the client devices 640. The virtual applications 628 are typically constructed in accordance with the tenant-specific metadata 638, which describes the particular tables, reports, interfaces and/or other features of the particular application 628. In various embodiments, each virtual application 628 generates dynamic web content that can be served to a browser or other client program 642 associated with its client device 640, as appropriate.

The runtime application generator 620 suitably interacts with the query generator 614 to efficiently obtain multi-tenant data 632 from the database 630 as needed in response to input queries initiated or otherwise provided by users of the client devices 640. In a typical embodiment, the query generator 614 considers the identity of the user requesting a particular function (along with the user's associated tenant), and then builds and executes queries to the database 630 using system-wide metadata 636, tenant specific metadata 638, pivot tables 634, and/or any other available resources. The query generator 614 in this example therefore maintains security of the common database 630 by ensuring that queries are consistent with access privileges granted to the user and/or tenant that initiated the request. In this manner, the query generator 614 suitably obtains requested subsets of data 632 accessible to a user and/or tenant from the database 630 as needed to populate the tables, reports or other features of the particular virtual application 628 for that user and/or tenant.

Still referring to FIG. 6, the data processing engine 612 performs bulk processing operations on the data 632 such as uploads or downloads, updates, online transaction processing, and/or the like. In many embodiments, less urgent bulk processing of the data 632 can be scheduled to occur as processing resources become available, thereby giving priority to more urgent data processing by the query generator 614, the search engine 616, the virtual applications 628, etc.

In exemplary embodiments, the application platform 610 is utilized to create and/or generate data-driven virtual applications 628 for the tenants that they support. Such virtual applications 628 may make use of interface features such as custom (or tenant-specific) screens 624, standard (or universal) screens 622 or the like. Any number of custom and/or standard objects 626 may also be available for integration into tenant-developed virtual applications 628. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. For example, a virtual CRM application may utilize standard objects 626 such as “account” objects, “opportunity” objects, “contact” objects, or the like. The data 632 associated with each virtual application 628 is provided to the database 630, as appropriate, and stored until it is requested or is otherwise needed, along with the metadata 638 that describes the particular features (e.g., reports, tables, functions, objects, fields, formulas, code, etc.) of that particular virtual application 628. For example, a virtual application 628 may include a number of objects 626 accessible to a tenant, wherein for each object 626 accessible to the tenant, information pertaining to its object type along with values for various fields associated with that respective object type are maintained as metadata 638 in the database 630. In this regard, the object type defines the structure (e.g., the formatting, functions and other constructs) of each respective object 626 and the various fields associated therewith.

Still referring to FIG. 6, the data and services provided by the server 602 can be retrieved using any sort of personal computer, mobile telephone, tablet or other network-enabled client device 640 on the network 645. In an exemplary embodiment, the client device 640 includes a display device, such as a monitor, screen, or another conventional electronic display capable of graphically presenting data and/or information retrieved from the multi-tenant database 630. Typically, the user operates a conventional browser application or other client program 642 executed by the client device 640 to contact the server 602 via the network 645 using a networking protocol, such as the hypertext transport protocol (HTTP) or the like. The user typically authenticates his or her identity to the server 602 to obtain a session identifier (“SessionID”) that identifies the user in subsequent communications with the server 602. When the identified user requests access to a virtual application 628, the runtime application generator 620 suitably creates the application at run time based upon the metadata 638, as appropriate. As noted above, the virtual application 628 may contain Java, ActiveX, or other content that can be presented using conventional client software running on the client device 640; other embodiments may simply provide dynamic web or other content that can be presented and viewed by the user, as desired.

The foregoing description is merely illustrative in nature and is not intended to limit the embodiments of the subject matter or the application and uses of such embodiments. Furthermore, there is no intention to be bound by any expressed or implied theory presented in the technical field, background, or the detailed description. As used herein, the word “exemplary” means “serving as an example, instance, or illustration.” Any implementation described herein as exemplary is not necessarily to be construed as preferred or advantageous over other implementations, and the exemplary embodiments described herein are not intended to limit the scope or applicability of the subject matter in any way.

For the sake of brevity, conventional techniques related to on-demand applications, console systems, user interfaces, web browsers, and other functional aspects of the systems (and the individual operating components of the systems) may not be described in detail herein. In addition, those skilled in the art will appreciate that embodiments may be practiced in conjunction with any number of system and/or network architectures, data transmission protocols, and device configurations, and that the system described herein is merely one suitable example. Furthermore, certain terminology may be used herein for the purpose of reference only, and thus is not intended to be limiting. For example, the terms “first”, “second” and other such numerical terms do not imply a sequence or order unless clearly indicated by the context.

Embodiments of the subject matter may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processing systems or devices can carry out the described operations, tasks, and functions by manipulating electrical signals representing data bits at accessible memory locations, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any non-transitory medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like. In this regard, the subject matter described herein can be implemented in the context of any computer-implemented system and/or in connection with two or more separate and distinct computer-implemented systems that cooperate and communicate with one another. In one or more exemplary embodiments, the subject matter described herein is implemented in conjunction with a virtual customer relationship management (CRM) application in a multi-tenant environment.

In summary, what has been described are improved systems and method for managing user interfaces, such as consoles or “control panels” associated with database systems, providing a user interface scheme in which certain components of the main workspace can be “popped-out” in such a way that they may be advantageously arranged by the user over one or more monitors. At the same time, operations performed on the main workspace are reflected in the appropriate pop-up window(s) and/or operations performed within the pop-up window(s) are reflected in the main workspace (and, optionally, other pop-up windows).

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A method for accessing a database system, the method comprising:
displaying, on a first display, a main workspace user interface including a plurality of components associated with the database system;
receiving, via the main workspace user interface, a request to create a pop-out representation of a selected component;
displaying, on at least one of the first display and a second display, the pop-out representation of the selected component;
modifying data of the database system in accordance with an operation performed via the main workspace user interface; and
managing the pop-out representation of the selected component based on the operation performed via the main workspace user interface.

2. The method of claim 1, wherein the main workspace is a web-based user interface including a page displayed via a web browser.

3. The method of claim 2, wherein the page includes software instructions executable by the web browser to create the pop-out representation of the selected component.

4. The method of claim 3, wherein the page includes software instructions executable by the web browser to manage the pop-out representation of the selected component.

5. The method of claim 4, wherein the software instructions are Javascript software instructions.

6. The method of claim 1, wherein the database system is a multi-tenant system.

7. The method of claim 1, wherein the main workspace user interface is displayed on the first monitor, and the pop-out representation of the selected component is displayed on the second monitor.

8. The method of claim 1, wherein the state of the pop-out representation is stored in a memory.

9. An apparatus comprising:
a database system;
a computing device configured to:
display, on a first display, a main workspace user interface including a plurality of components associated with the database system;
receive, via the main workspace user interface, a request to create a pop-out representation of a selected component;
display, on at least one of the first display and a second display, the pop-out representation of the selected component;
modify data of the database system in accordance with an operation performed via the main workspace user interface;
manage the pop-out representation of the selected component based on the operation performed via the main workspace user interface.

10. The apparatus of claim 9, wherein the main workspace is a web-based user interface and the page is displayed via a web browser.

11. The apparatus of claim 10, wherein the page includes software instructions executable by the web browser to create the pop-out representation of the selected component.

12. The apparatus of claim 11, wherein the page includes software instructions executable by the web browser to manage the pop-out representation of the selected component.

13. The apparatus of claim 12, wherein the software instructions are Javascript software instructions.

14. The apparatus of claim 9, wherein the database system is a multi-tenant system.

15. The apparatus of claim 9, wherein the main workspace user interface is displayed on the first monitor, and the pop-out representation of the selected component is displayed on the second monitor.

16. The apparatus of claim 9, wherein the state of the pop-out representation is stored in a memory.

17. A non-transitory machine-readable medium including instructions for creating a field for a database object in a database system, which instructions, when executed by a processor, causes the processor to perform the steps of:
displaying, on a first display, a main workspace user interface including a plurality of components associated with the database system;
receiving, via the main workspace user interface, a request to create a pop-out representation of a selected component;
displaying, on at least one of the first display and a second display, the pop-out representation of the selected component;
modifying data of the database system in accordance with an operation performed via the main workspace user interface;
managing the pop-out representation of the selected component based on the operation performed via the main workspace user interface.

18. The non-transitory machine-readable medium of claim 17, wherein the main workspace is a web-based user interface and the page is displayed via a web browser.

19. The non-transitory machine-readable medium of claim 18, wherein the page includes software instructions executable by the web browser to create the pop-out representation of the selected component.

20. The non-transitory machine-readable medium of claim 19, wherein the page includes software instructions executable by the web browser to manage the pop-out representation of the selected component.
